(19) United States
(12) Patent Application Publication
(10) Pub. No.: US 2016/0003683 A1
(43) Pub. Date: Jan. 7, 2016

(54) REMOTE TEMPERATURE SENSING

(71) Applicant: Infineon Technologies AG, Neubiberg (DE)

(72) Inventors: Yoon Hwee Leow, Singapore (SG); Thanh Yen Nguyen, Singapore (SG)

(21) Appl. No.: 14/321,581

(22) Filed: Jul. 1, 2014

(51) Int. Cl. G01K 1/02; G01K 7/01

(52) U.S. Cl. CPC G01K 1/024; G01K 7/01

(57) ABSTRACT

An example method includes determining, based on a local V_{BE} value and a local ΔV_{BE} value that represents a difference between a pair of local voltage values, a first value that corresponds to a temperature of a local sensor core, wherein a local voltage value of the pair of local voltage values corresponds to a voltage drop across a local p-n junction of the local sensor core; determining, based on a local V_{BE} value and a remote ΔV_{BE} value that represents a difference between a pair of remote voltage values, a second value that corresponds to a temperature of a remote sensor core, wherein the pair of remote voltage values each correspond to respective voltage drops across a remote p-n junction of the remote sensor core. The example method also includes determining the temperature of the remote sensor core based at least on the first value and the second value.

### TECHNICAL FIELD

This disclosure relates to remote temperature sensing, and in particular, to remote temperature sensing using a p-n junction.

### BACKGROUND

The ability to accurately measure temperature may be beneficial for the operation of a device and/or system. In some examples, a p-n junction may be used to measure temperature. Due to their physical properties, the voltage drop across a p-n junction may be related to the temperature of the p-n junction through equation (1), below, where V_{T} is the voltage drop across the p-n junction, K is the Boltzmann's constant (e.g., ˜1.380*10⁻²³ Joules per degree Kelvin), T is the absolute temperature of the p-n junction in degrees Kelvin, q is the elementary charge (e.g., ˜1.602*10⁻¹⁹ Coulombs), I_{Bias} is the current at which the p-n junction is biased, and I_{S} is the saturation current of the p-n junction.

$${V}_{T} = \frac{K \cdot T}{q} ln ( \frac{{I}_{Bias}}{{I}_{S}} ) \qquad ( 1 )$$

### SUMMARY

In general, this disclosure is directed to techniques for determining the temperature of a remote p-n junction without requiring the use of a temperature invariant current source. For instance, a device may determine a temperature of a remote sensor core that includes a remote p-n junction based on a voltage drop across the remote p-n junction and a voltage drop across a local p-n junction included in a local sensor core.

In one example, a method includes determining, based on a first local V_{BE} value and a local ΔV_{BE} value that represents a difference between a pair of local voltage values, a first value that corresponds to a temperature of a local sensor core, wherein a first local voltage value of the pair of local voltage values corresponds to a first voltage drop across a local p-n junction of the local sensor core, and wherein the first local V_{BE} value corresponds to a second voltage drop across the local p-n junction of the local sensor core. In this example, the method also includes determining, based on a second local V_{BE} value and a remote ΔV_{BE} value that represents a difference between a pair of remote voltage values, a second value that corresponds to a temperature of a remote sensor core, wherein the second local V_{BE} value corresponds to a third voltage drop across the local p-n junction, and wherein the pair of remote voltage values each correspond to respective voltage drops across a remote p-n junction of the remote sensor core while the remote p-n junction is biased at different respective current levels. In this example, the method also includes determining the temperature of the remote sensor core based at least on the first value and the second value.

In another example, a device includes an analog-to-digital converter (ADC) configured to determine, based on a first local V_{BE} value and a local ΔV_{BE} value that represents a difference between a pair of local voltage values, a first value that corresponds to a temperature of a local sensor core, wherein a first voltage value of the pair of local voltage values corresponds to a first voltage drop across a local p-n junction of the local sensor core, and wherein the first local V_{BE} value corresponds to a second voltage drop across the local p-n junction of the local sensor core. In this example, the ADC is further configured to determine, based on a second local V_{BE} value and a remote ΔV_{BE} value that represents a difference between a pair of remote voltage values, a second value that corresponds to a temperature of a remote sensor core, wherein the second local V_{BE} value corresponds to a third voltage drop across the local p-n junction, and wherein the pair of mixed voltage values each correspond to respective voltage drops across a remote p-n junction of the remote sensor core while the remote p-n junction is biased at difference respective current levels. In this example, the device also includes one or more processors configured to determine the temperature of the remote sensor core based at least on the first value and the second value.

In another example, a device includes means for determining, based on a first local V_{BE} value and a local ΔV_{BE} value that represents a difference between a pair of local voltage values, a first value that corresponds to a temperature of a local sensor core, wherein a first local voltage value of the pair of local voltage values corresponds to a first voltage drop across a local p-n junction of the local sensor core, and wherein the first local V_{BE} value corresponds to a second voltage drop across the local p-n junction of the local sensor core. In this example, the device also includes means for determining, based on a second local V_{BE} value and a remote ΔV_{BE} value that represents a difference between a pair of remote voltage values, a second value that corresponds to a temperature of a remote sensor core, wherein the second local V_{BE} value corresponds to a third voltage drop across the local p-n junction, and wherein the pair of remote voltage values each correspond to respective voltage drops across a remote p-n junction of the remote sensor core while the remote p-n junction is biased at different respective current levels. In this example, the device also includes means for determining the temperature of the remote sensor core based at least on the first value and the second value.

Details of these and other examples are set forth in the accompanying drawings and the description below. Other features, objects, and advantages will be apparent from the description and drawings, and from the claims.

### BRIEF DESCRIPTION OF DRAWINGS

FIG. 1 is a conceptual diagram illustrating an exemplary system that includes a device for determining the temperature of a remote p-n junction, in accordance with one or more techniques of this disclosure.

FIG. 2 is a conceptual diagram illustrating exemplary analog-to-digital converter (ADC) that is configured to generate a digital representation of an analog signal, in accordance with one or more techniques of this disclosure.

FIG. 3 is a conceptual diagram illustrating exemplary system 2C that includes a device for determining the temperature of a p-n junction, in accordance with one or more techniques of this disclosure.

FIG. 4 is a conceptual diagram illustrating exemplary system 2D that includes a device for determining the temperature of a remote p-n junction, in accordance with one or more techniques of this disclosure.

FIG. 5 is a flowchart illustrating exemplary operations of a device configured to determine the temperature of a remote p-n junction, in accordance with one or more techniques of this disclosure.

FIG. 6 is a graph illustrating an exemplary relationship between charging current and temperature of a battery, in accordance with one or more techniques of this disclosure.

FIG. 7 is a graph illustrating exemplary temperature levels of a battery, in accordance with one or more techniques of this disclosure.

FIG. 8 is a conceptual diagram illustrating an exemplary system that includes a device for determining the temperature of a remote p-n junction that is physically located near a battery, in accordance with one or more techniques of this disclosure.

### DETAILED DESCRIPTION

In general, this disclosure is directed to techniques for determining a temperature of a p-n junction. In some examples, it may not be desirable to position a p-n junction near the device and/or system that uses a voltage drop across the p-n junction to determine the temperature of the p-n junction. In other words, it may be desirable for a device and/or system to determine the temperature of a remotely positioned p-n junction. In some examples, in order to determine the voltage drop across the remote p-n junction, the device and/or system may cause a current source to bias the remote p-n junction with a current. However, in some examples, an error may be introduced because the current level output by the current source may be dependent on temperature. As such, in some examples, a temperature invariant current source may be used to reduce the error. However, in some examples, it may not be desirable to require the use of a temperature invariant current source. For instance, the temperature invariant current source may be dependent on a bandgap reference that may provide, in the first order, a temperature invariant reference for the conversion, the second order curvature effect can result in errors that can be difficult to eliminate.

In some examples, as opposed a bandgap voltage with good first order characteristics but large second order curvature errors that can be difficult to compensate for, it may be desirable to use a PTAT (Positively Correlated with Absolute Temperature) reference due to its less pronounced second order curvature characteristics. The first order positive correlation with absolute temperature gradient may be eliminated, e.g., in the digital representation.

However, when measuring temperature using only remotely positioned p-n junctions, the use of a PTAT current may not be desirable. For instance, where a p-n junction is placed at a remote sensing location with a stable temperature under thermal equilibrium, a reference current has to be sourced from the device (e.g., chip) that includes the temperature processing components. If a PTAT current is used to bias the remote p-n junction, an error may be introduced because the local temperature of the remote p-n junction can be different from the device. Under such a scenario, the sensed voltage generated across the p-n junction can be different for a varying differential temperature between the local and remote sensor location.

In accordance with one or more techniques of this disclosure, a device may determine a temperature of a remote p-n junction by performing a local sensing operation using one or more local p-n junctions, and a mixed sensing operation using a remote p-n junction and at least one local p-n junction. In this way, the device may cancel out the error introduced by any temperature differences between the device and the remote p-n junction.

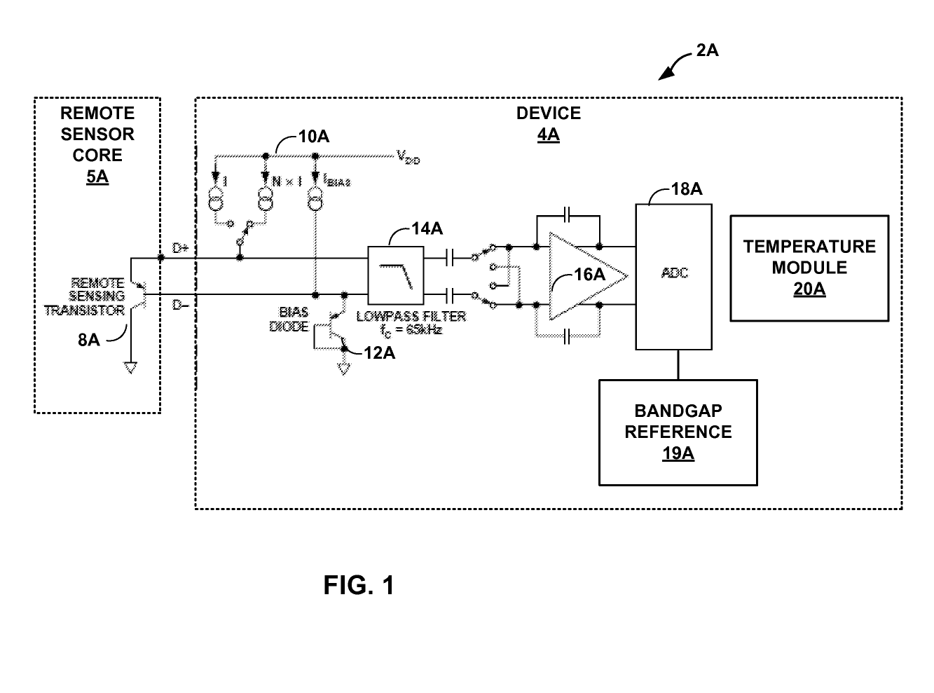

FIG. 1 is a conceptual diagram illustrating exemplary system 2A that includes a device for determining the temperature of a remote p-n junction, in accordance with one or more techniques of this disclosure. As illustrated in the example of FIG. 1, system 2A may include device 4A, and remote sensor core 5A.

In some examples, system 2A may include remote sensor core 5A which may be configured to sense a temperature. For instance and as illustrated in FIG. 1, remote sensor core 5A may include remote p-n junction 8A which, as discussed above, may be configured to output a voltage signal as a function of temperature.

In some examples, system 2A may include device 4A which may be configured to determine the temperature of a p-n junction. For instance, device 4A may be configured to determine the temperature of remote p-n junction 8A of remote sensor core 5A. As illustrated in FIG. 1, device 4A may include current source 10A, bias diode 12A, lowpass filter 14A, amplifier 16A, analog-to-digital converter (ADC) 18A, and temperature module 20A.

In some examples, device 4A may include current source 10A which may be configured to output one or more currents. In some examples, current source 10A may be configured to output a plurality of ratiometric currents (e.g., first current I and second current N*I). As illustrated in FIG. 1, current source 10A may be configured to output one or more of the currents so as to bias remote p-n junction 8A.

In some examples, device 4A may include bias diode 12A which may be configured to reduce the noise at the base of remote p-n junction 8A. In some examples, by including bias diode 12A, the noise at the base of remote p-n junction 8A may be reduced as compared to shorting the base of remote p-n junction 8A to ground.

In some examples, device 4A may include lowpass filter 14A which may be configured to reduce and/or eliminate frequency components of a voltage signal generated by remote p-n junction 8A. In some examples, lowpass filter 14A may have a cutoff frequency of 65 kHz.

In some examples, device 4A may include amplifier 16A which may be configured to act as a driver for ADC 18A. In some examples, amplifier 16A may be a chopper stabilized amplifier.

In some examples, device 4A may include ADC 18A which may be configured to determine a digital representation of an analog voltage signal. For instance, ADC 18A may be configured to determine a digital representation of the analog voltage signal received from amplifier 16A. In some examples, ADC 18A may utilize a bandgap voltage signal generated by bandgap reference 19A as a reference when determining the digital representation of an analog voltage signal.

In some examples, device 4A may include temperature module 20A which may be configured to determine the temperature of remote p-n junction 8A. As discussed above, the voltage drop across a p-n junction is a function of the temperature of the p-n junction, constants (e.g., the Boltzmann's constant and the elementary charge), the bias current of the p-n junction, and the saturation current of the p-n junction. As the saturation current of a p-n junction may vary as a result of many conditions (e.g., manufacturing, life cycle, etc.), it may be desirable to remove the dependence on saturation current when determining the temperature of the p-n junction. As such, temperature module 20A may be configured to determine the temperature of remote p-n junction 8A independent of the saturation current of remote p-n junction 8A. As one example, temperature module 20A may determine the temperature of remote p-n junction 8A based on two voltage values that correspond to respective voltage drops across remote p-n junction 8A while remote p-n junction 8A is biased at different respective current levels. As the saturation current of remote p-n junction 8A is a property of the transistor and will remain unchanged at either of the different respective current levels, temperature module 20A may determine the temperature of remote p-n junction 8A in accordance with equation (2), below, where V_{BE1} is the voltage drop across remote p-n junction 8A while remote p-n junction 8A is biased at first current I, V_{BE2} is the voltage drop across remote p-n junction 8A while remote p-n junction 8A is biased at second current N·I, K is the Boltzmann's constant (e.g., ˜1.380*10⁻²³ Joules per degree Kelvin), T is the absolute temperature of remote p-n junction 8A in degrees Kelvin, q is the elementary charge (e.g., ˜1.602*10⁻¹⁹ Coulombs), I_{Bias} is the current at which the p-n junction is biased, I_{S} is the saturation current of remote p-n junction 8A, and N is an integer that represents the ratio of the first current to the second current. Solving equation (2) may for T results in equation (3).

$$\begin{matrix}{V}_{BE 1} - {V}_{BE 2} = Δ {V}_{BE} = \frac{K \cdot T}{q} ln ( \frac{I}{N \cdot I} ) = \frac{K \cdot T}{q} ln ( \frac{1}{N} ) & ( 2 ) \\ T = Δ {V}_{BE} \frac{q}{K \cdot ln ( \frac{1}{N} )} & ( 3 )\end{matrix}$$

In operation, current source 10A may output first current I as to bias remote p-n junction 8A with first current I at a first time. As a result of being biased with the first current, remote p-n junction 8A may generate a first analog signal representative of a first voltage drop (e.g., V_{BE1}). The first analog signal may be filtered by lowpass filter 14A and amplified by amplifier 16A to generate a filtered-amplified first analog signal. ADC 18A may determine a first digital value that represents the filtered-amplified first analog signal and output the first digital value to temperature module 20A.

Current source 10A may output second current N·I as to bias remote p-n junction 8A with second current N·I at a second time. As a result of being biased with the second current, remote p-n junction 8A may generate a second analog signal representative of a second voltage drop (e.g., V_{BE2}). The second analog signal may be filtered by lowpass filter 14A and amplified by amplifier 16A to generate a filtered-amplified second analog signal. ADC 18A may determine a second digital value that represents the filtered-amplified second analog signal and output the second digital value to temperature module 20A.

Temperature module 20A may determine the temperature of remote p-n junction 8A based on the first digital value, the second digital value, and the ratio between the first current and the second current. For instance, temperature module 20A may determine the temperature of remote p-n junction 8A in accordance with equation (3), above.

However, in some examples, the accuracy of the temperature value determined temperature module 20A may be reduced as a result of imperfections in the signal generated by bandgap reference 19A. As such, in some examples, it may be desirable to reduce or eliminate the use of bandgap reference 19A when determining the temperature of a p-n junction.

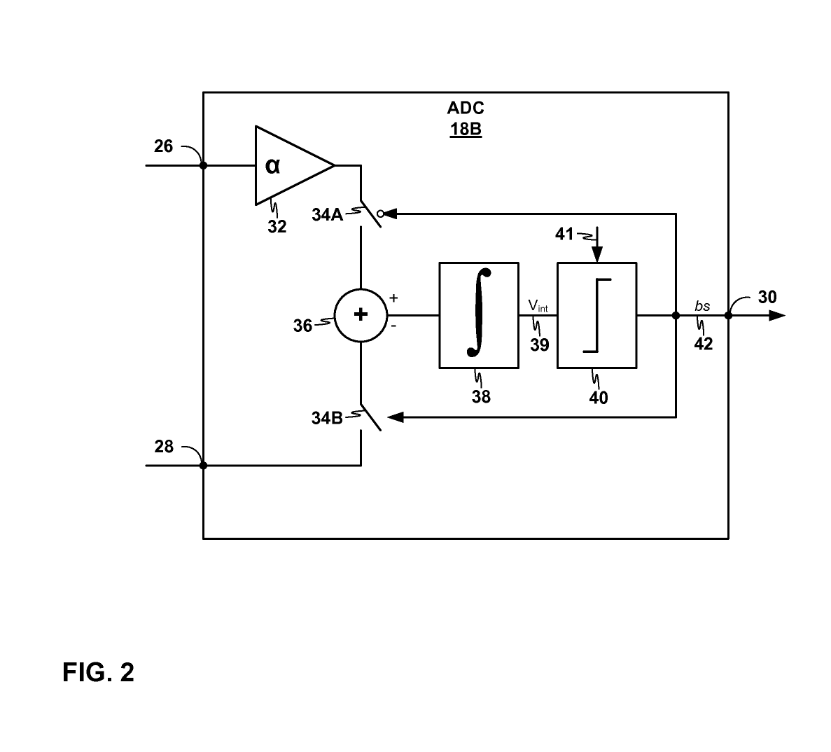

FIG. 2 is a conceptual diagram illustrating exemplary analog-to-digital converter (ADC) 18B that is configured to generate a digital representation of an analog signal, in accordance with one or more techniques of this disclosure. In some examples, ADC 18B may comprise a sigma-delta ADC, such as a charge-sharing sigma-delta ADC. As illustrated in the example of FIG. 2, ADC 18B may include first analog input 26, second analog input 28, digital output 30, amplifier 32, first switch 34A, second switch 34B, subtractor 36, integrator 38, and comparator 40. In some examples, such as the example of FIG. 2, ADC 18B may include a first-order filter. In some examples, ADC 18B may include higher order filters, such as a second order filter, a third order filter, etc.

In some examples, ADC 18B may include amplifier 32 which may be configured to amplify the signal received at first input 2 with a gain of α. For instance, if the signal received at first input 26 is V₂₆, amplifier 32 may output α V₂₆ to switch 34A. While amplifier 32 is illustrated in FIG. 2 as an amplification unit, amplifier 32 may be implemented through a variety of methods as discussed in further detail below.

In some examples, ADC 18B may include first switch 34A and second switch 34B (collectively, “switches 34”) which may be configured to couple first input 26 and second input 28 to adder 36. In some examples, switches 34 may be configured to couple the inputs based on the value of bitstream 42. As one example, switch 34B may be configured to couple second input 28 to subtractor 36 where the value of bitstream 42 is a first logical value. As another example, switch 34A may be configured to couple first input 26 to adder 36 where the value of bitstream 42 is a second logical value. In other words, the control signal for switch 34A may an inverted version of the control signal for switch 34B which may be bitstream 42.

In some examples, ADC 18B may include subtractor 36 which may be configured to subtract a first input value from a second input value to determine an output value. As one example, subtractor 36 may subtract a first input value received from switch 34A from a second input value received from switch 34B to determine an output value which may be provided to integrator 38. In some examples, if switch 34A is open, the first input value may be zero. In some examples, if switch 34B is open, the second input value may be zero.

In some examples, ADC 18B may include integrator 38 which, together with switches 34 and subtractor 36, may be configured as a loop filter that outputs loop filter output 39 to comparator 40. In some examples, ADC 18B may include comparator 40 which may be configured to determine bitstream 19 based on loop filter output 39. In some examples, comparator 40 may be a clocked comparator configured to produce a bit of bitstream 19 based on the polarity of loop filter output 39 for each cycle of clock signal 41. In some examples, the feedback may be arranged so as to drive the output of integrator 38 to zero.

In operation, if the value of bitstream 42 in any given cycle of clock signal 41 is a logical low value, switch 34A may close and switch 34B may open such that integrator 38 may integrate the output of amplifier 32 minus zero (i.e., α·V₂₆−0). If the value of bitstream 42 in any given cycle of clock signal 41 is a logical high value, switch 34A may open and switch 34B may close such that integrator 38 may integrate zero minus the signal at second input 17B (i.e., 0−V₂₈). As a result of the feedback in ADC 18B, the average input to integrator 38 may be zero. In other words, the charge added by the output of amplifier 32 may be removed by the signal at second input 28. If the average value of bitstream 42 is μ, this charge balancing may be expressed in accordance with equation (4), below, where V₂₆ is the signal at first input 26, and V₂₈ is the signal at second input 29.

(1−μ)·α·V₂₆=μ·V₂₈ (4)

Re-arranging equation (4) may yield equation (5), below.

$$μ = \frac{α \cdot {V}_{26}}{{V}_{28}} \qquad ( 5 )$$

In other words, ADC 18B may implement a charge balancing scheme to determine bitstream 42 as a digital representation of the difference between the analog signal at first input 26 and the analog signal at second input 28. ADC 18B may output bitstream 42 to one or more other components via output 30. Additionally, ADC 18B is configured to determine bitstream 42 without the error introduced by a bandgap reference, such as bandgap reference 19A of FIG. 1.

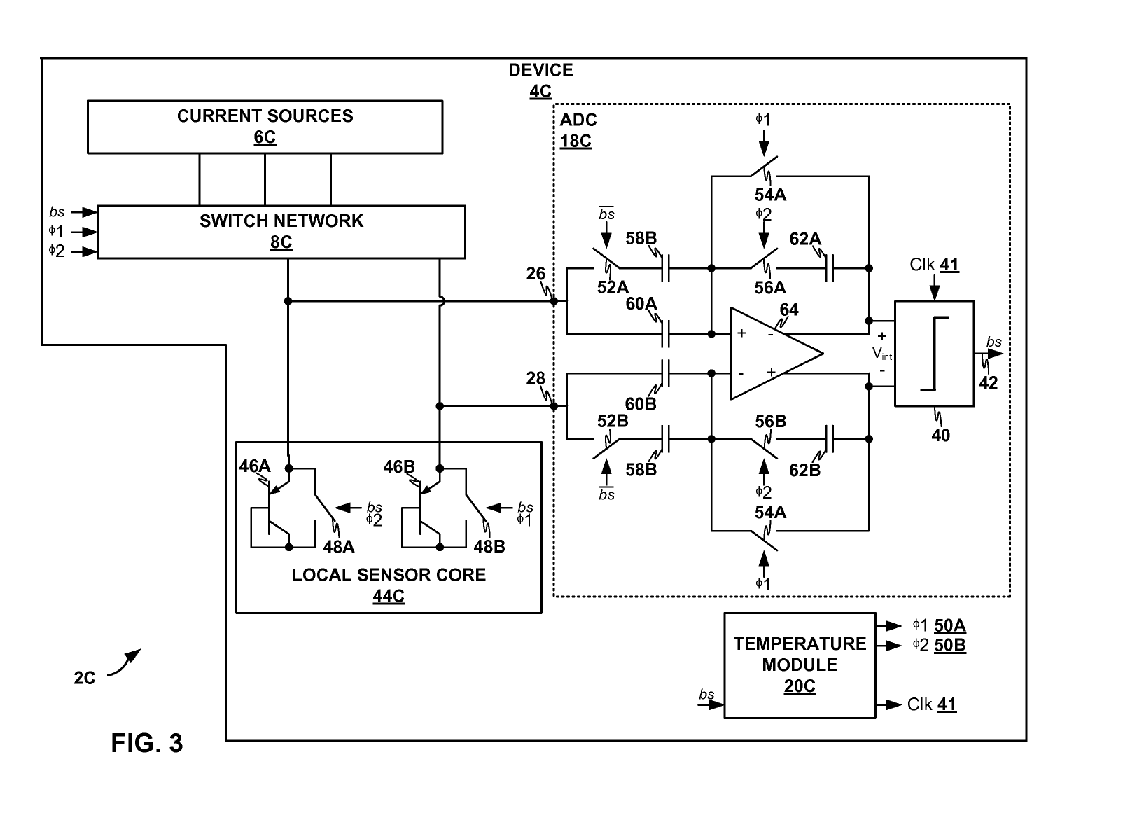

FIG. 3 is a conceptual diagram illustrating exemplary system 2C that includes a device for determining the temperature of a p-n junction, in accordance with one or more techniques of this disclosure. As illustrated in the example of FIG. 3, system 2C may include device 4C which may be configured to perform operations similar to device 4A of FIG. 1. For instance, device 4C may be configured to determine the temperature of a p-n junction. In contrast to device 4A, device 4C may be configured to determine the temperature of a local p-n junction, as opposed to a remote p-n junction. As illustrated in FIG. 3, device 4C may include current sources 6C, switch network 8C, ADC 18C, temperature module 20C, and local sensor core 44C.

In some examples, device 4C may include current sources 6C which may be configured to output a plurality of different currents. In some examples, the plurality of currents output by current sources 6C may be ratiometric currents, meaning that the currents are integer multiples of each other. In some examples, current sources 6C may be configured to simultaneously output the plurality of different currents.

In some examples, device 4C may include switch network 8C which may be configured to selectively direct received signals to one or more destinations. In some examples, switch network 8C may selective direct the signals based on one or more control signals. For instance, switch network 8C may selectively direct currents received from current sources 6C to first local p-n junction 46A and/or second local p-n junction 46B based on first phase control signal 50A, second phase control signal 50B, and bitstream 42.

In some examples, device 4C may include ADC 18C which may be configured to perform operations similar to ADC 18B of FIG. 2. For instance, ADC 18C may be configured to determine bitstream 42 based on the signals at first analog input 26 and second analog input 28 without the error introduced by a bandgap reference, such as bandgap reference 19A of FIG. 1. As illustrated by FIG. 3, ADC 18C may include integrator 40, switch 52A and switch 52B (collectively “switches 52”), switch 54A and switch 54B (collectively “switches 54”), switch 56A and switch 56B (collectively “switches 56”), capacitor 58A and capacitor 58B (collectively “capacitors 58”), capacitor 60A and capacitor 60B (collectively “capacitors 60”), capacitor 62A and capacitor 62B (collectively “capacitors 62”), and amplifier 64.

In some examples, switches 52-56 may be configured to open and close based on one or more control signals. As one example, switches 52 may be configured to close where bitstream 42 is a logical low value and open where bitstream 42 is a logical high value. In this way, switches 52 may operate similar to switches 34 of FIG. 2. As another example, switches 54 may be configured to open where first phase control signal 50A is a logical high value and close where first phase control signal 50A is a logical low value. As another example, switches 56 may be configured to open where second phase control signal 50B is a logical high value and close where second phase control signal 50B is a logical low value.

In some examples, capacitors 58 may have a larger capacitance value than capacitors 60. In some examples, capacitors 58 are not used where bitstream 42 is a logical high value, and therefore, the ratio between the capacitance of capacitors 58 and capacitors 60 may be used to implement amplifier 32 of FIG. 2. For instance, where the capacitance of capacitors 58 is seven times larger than the capacitance of capacitors 60, a gain of 8× may be realized.

In some examples, device 4C may include temperature module 20C which may be configured to perform operations similar to temperature module 20A of FIG. 1. For instance, temperature module 20C may be configured to determine the temperature of a p-n junction. In contrast to device temperature module 20A, temperature module 20C may be configured to determine the temperature of a local p-n junction, as opposed to a remote p-n junction. Additionally, temperature module 20C may be configured to determine and output first phase control signal 50A, second phase control signal 50B, and clock signal 41.

Temperature module 20C may output first phase control signal 50A and second phase control signal 50B to cause system 2C to operate in two phases for each bit of bitstream 42 generated by ADC 18C. As one example, during the first phase for a current bit of bitstream 42, temperature module 20C may output first phase control signal 50A as a logical high value and second phase control signal 50B as a logical low value. As another example, during the second phase for the current bit of bitstream 42, temperature module 20C may output second phase control signal 50B as a logical high value and first phase control signal 50A as a logical low value.

In some examples, device 4C may include local sensor core 44C which may be configured to perform operations similar to remote sensor core 5A of FIG. 1. For instance, local sensor core 44C may be configured to sense a temperature. However, in contrast to remote sensor core 5A which is positioned remotely from device 4A, local sensor core 44C may be included within device 4C or located adjacent to device 4C. As illustrated in FIG. 3, local sensor core 44C may include first local p-n junction 46A and second local p-n junction 46B (collectively “local p-n junctions 46”), and first shunting switch 48A and second shunting switch 48B (collectively “shunting switches 48”).

Shunting switches 48 may be configured to selectively shunt first input 26 and second input 28 of ADC 18C based on one or more control signals. As one example, where bitstream 42 and first phase control signal 50A are both logical high values, second shunting switch 48B may shunt second local p-n junction 46B such that the voltage drop across second local p-n junction 46B is zero. As another example, where bitstream 42 and second phase control signal 50B are both logical high values, first shunting switch 48A may shunt first local p-n junction 46A such that the voltage drop across first local p-n junction 46A is zero.

In accordance with one or more techniques of this disclosure, temperature module 20C may determine a temperature of one or both of p-n junctions 46 of local sensor core 44C. For instance, temperature module 20C may determine the temperature of one or both of p-n junctions 46 by causing system 2C to operate in two phases for each bit of bitstream 42. As one example, if a current bit of bitstream 42 is a logical low value, temperature module 20C may cause ADC 18C to integrate a ΔV_{BE} value that corresponds to a difference between a voltage drop across first local p-n junction 46A while first local p-n junction 46A is biased with a first current and a voltage drop across second local p-n junction 46B while second local p-n junction 46B is biased with a second current. As another example, if a current bit of bitstream 42 is a logical high value, temperature module 20C may cause ADC 18C to integrate a V_{BE} value that corresponds to a voltage drop across second local p-n junction 46B while second local p-n junction 46B is biased with a third current.

In some examples, temperature module 20C may cause ADC 18C to integrate the ΔV_{BE} value in two phases. During a first phase, temperature module 20C may output first phase control signal 50A as a logical high value such that switch network 8C directs the first current to first local p-n junction 46A and the second current to second local p-n junction 46B, and that switches 54 close. During a second phase, temperature module 20C may output second phase control signal 50B as a logical high value such that switch network 8C directs the second current to first local p-n junction 46A and the first current to second local p-n junction 46B, and that switches 56 close. As such, during the second phase, temperature module 20C may cause the biasing currents of the local p-n junctions 46 to be swapped with reference to the first phase. Therefore, the change in the value of loop filter output 39 throughout both phases may be proportional to 2ΔV_{BE}. Additionally, as the value of the current bit of bitstream 42 is logical low while ADC 18C integrates the ΔV_{BE} value, switches 52 are also closed and switches 48 are open during both phases of ΔV_{BE} integration.

In some examples, temperature module 20C may cause ADC 18C to integrate the V_{BE} value in two phases. During a first phase, temperature module 20C may output first phase control signal 50A as a logical high value such that switch network 8C directs the third current to first local p-n junction 46A, and that switches 54 close. Additionally, shunting switch 48B may also close during the first phase because the value of the current bit of bitstream 42 is also logical high while ADC 18C integrates the V_{BE} value. Therefore, the voltage across input 26 and input 28 is V_{BE 46A} during the first phase. During a second phase, temperature module 20C may output second phase control signal 50B as a logical high value such that switch network 8C directs the third current to second local p-n junction 46B, and that switches 56 close. Additionally, shunting switch 48A may also close during the second phase because the value of the current bit of bitstream 42 is also logical high while ADC 18C integrates the V_{BE} value. Therefore, the voltage across input 26 and input 28 is −V_{BE 46B} during the second phase. As such, during the second phase, temperature module 20C may cause the biasing currents of the local p-n junctions 46 to be swapped with reference to the first phase. Therefore, the change in the value of loop filter output 39 throughout both phases may be proportional to −(V_{BE 46A}+V_{BE 46B}) such that the average base-emitted voltage of local p-n junctions 46 may be utilized. Additionally, as the value of the current bit of bitstream 42 is logical high while ADC 18C integrates the V_{BE} value, switches 52 are also open during both phases of V_{BE} integration.

In some examples, temperature module 20C may perform the above techniques once when determining a next bit of bitstream 42. For instance, if the current bit of bitstream 42 is logical low temperature module 20C may perform the corresponding first phase and second phase once each to cause ADC 18C to integrate the ΔV_{BE} value. In some examples, temperature module 20C may perform the above techniques several times when determining a next bit of bitstream 42. For instance, if the current bit of bitstream 42 is logical high temperature module 20C may perform the corresponding first phase and second phase twice each to cause ADC 18C to integrate the V_{BE} value twice. In either case, temperature module 20C may output clock signal 41 as logical high to cause comparator 40 to determine the next bit of bitstream 42.

Temperature module 20C may repeat some or all of the above techniques to determine a plurality of bits of bitstream 42. Using the determined plurality of bits of bitstream 42, temperature module 20C may determine the temperature of one or both of local p-n junctions 46. For instance, as discussed above, if the average value of bitstream 42 is μ, temperature module 20C may determine the temperature of one or both of local p-n junctions 46 in accordance with equations (6)-(7), below where ΔV_{BE} is the signal integrated where the current bit of bitstream 42 is logical low, V_{BE} is the signal integrated where the current bit of bitstream 42 is logical high, A and B are scaling values.

$$\begin{matrix}μ = \frac{α \cdot Δ {V}_{BE}}{{V}_{BE} + α \cdot Δ {V}_{BE}} & ( 6 ) \\ T = A \cdot μ + B & ( 7 )\end{matrix}$$

As discussed above, it may be desirable to determine the temperature of a remote p-n junction, as opposed to a local p-n junction. However, simply repositioning local sensor core 44C remote from device 4C may not be desirable. As one example, where the currents output by current sources 6C are proportional to absolute temperature (PTAT), differences in temperature between the remotely positioned local sensor core 44C and current sources 6C may result in errors. As another example, where the currents output by current sources 6C are based on a bandgap reference, the measurements may be adversely affected by supply voltage and process variations (PVT) of the bandgap reference.

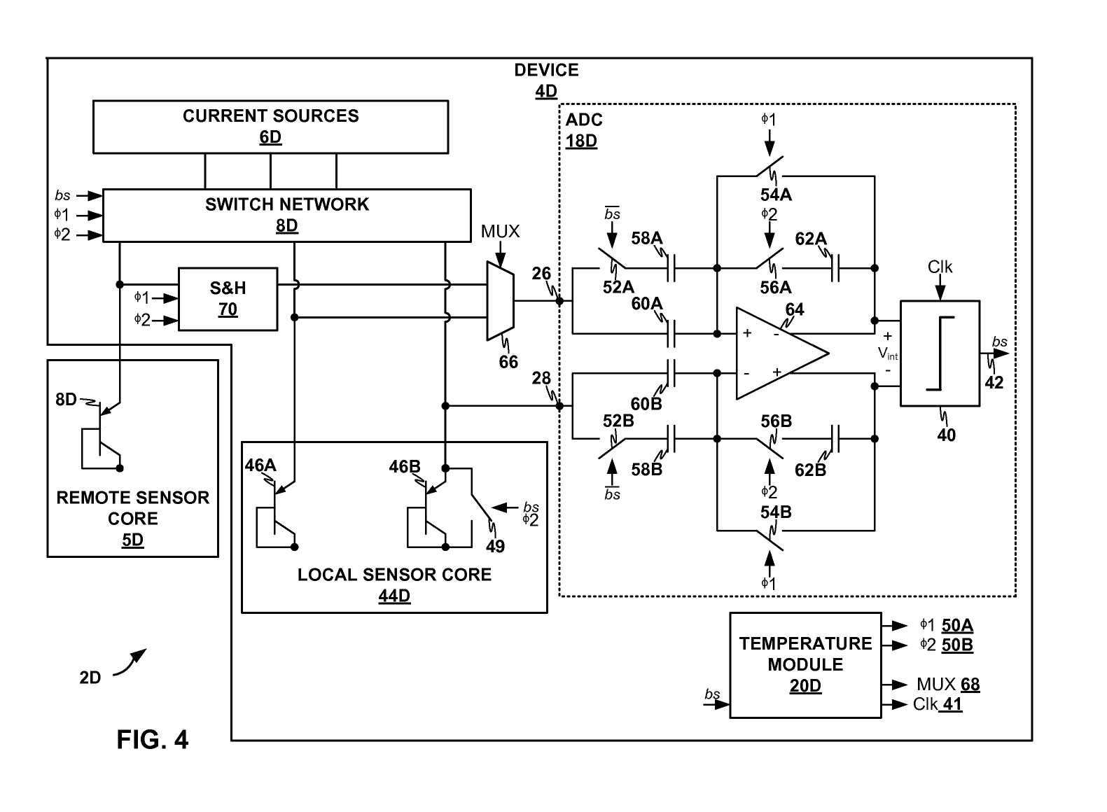

FIG. 4 is a conceptual diagram illustrating exemplary system 2D that includes a device for determining the temperature of a remote p-n junction, in accordance with one or more techniques of this disclosure. As illustrated in the example of FIG. 4, system 2D may include device 4D and remote sensor core 5D. In some examples, device 4D may be configured to perform operations similar to device 4A of FIG. 1 and device 4C of FIG. 3. For instance, device 4D may be configured to determine the temperature of a p-n junction. In contrast to device 4A, device 4D may be configured to determine the temperature of a remote p-n junction without the error introduced by a bandgap reference. In contrast to device 4C, device 4D may be configured to determine the temperature of a remote p-n junction. Examples of device 4D may include but are not limited to one or more processors, including, one or more microprocessors, digital signal processors (DSPs), application specific integrated circuits (ASICs), field programmable gate arrays (FPGAs), or any other equivalent integrated or discrete logic circuitry, as well as any combinations of such components. As illustrated in FIG. 4, device 4D may include current sources 6D, switch network 8D, ADC 18D, temperature module 20D, local sensor core 44D, multiplexer 66, and sample and hold (S&H) 70.

In some examples, device 4D may include current sources 6D which may be configured to perform operations similar to current sources 6C of FIG. 3. For instance, current sources 6D may be configured to output a plurality of different currents. In some examples, the plurality of currents output by current sources 6D may be ratiometric currents, meaning that the currents are integer multiples of each other. In some examples, current sources 6D may be configured to simultaneously output the plurality of different currents.

In some examples, device 4D may include switch network 8D which may be configured to perform operations similar to switch network 8C of FIG. 3. For instance, switch network 8D may be configured to selectively direct received signals to one or more destinations. In some examples, switch network 8D may selective direct the signals based on one or more control signals. For instance, switch network 8D may selectively direct currents received from current sources 6D to first local p-n junction 46A, second local p-n junction 46B, and/or remote p-n junction 8D based on first phase control signal 50A, second phase control signal 50B, and bitstream 42.

In some examples, device 4D may include ADC 18D which may be configured to perform operations similar to ADC 18B of FIG. 2 and/or ADC 18C of FIG. 3. For instance, ADC 18D may be configured to determine bitstream 42 based on the signals at first analog input 26 and second analog input 28 without the error introduced by a bandgap reference, such as bandgap reference 19A of FIG. 1.

In some examples, device 4D may include multiplexer 66 which may be configured to selectively couple a particular input of a plurality of inputs to an output. In some examples, multiplexer 66 may selectively couple the particular input based on a control signal, such as a control signal received from temperature module 20 (e.g., multiplexer control signal 68). For instance, where a first input of the plurality of inputs of multiplexer 66 corresponds to the voltage drop across remote p-n junction 8D and a second input of the plurality of inputs corresponds to the voltage drop across first local p-n junction 46A, multiplexer 66 may selectively couple either the voltage drop across remote p-n junction 8D or the voltage drop across first local p-n junction 46A to an external device, such as first input 26 of ADC 18D.

In some examples, device 4D may include local sensor core 44D which may be configured to perform operations similar to local sensor core 44C of FIG. 3. For instance, local sensor core 44D may be configured to sense a temperature. As illustrated in FIG. 4, local sensor core 44D may include first local p-n junction 46A and second local p-n junction 46B (collectively “local p-n junctions 46”), and shunting switch 49. Examples of first local p-n junction 46A and second local p-n junction 46B include, but are not limited to, diodes, transistors, and the like.

Shunting switch 49 may be configured to selectively shunt second input 28 of ADC 18D based on one or more control signals. As one example, where bitstream 42 and first phase control signal 50A are both logical high values, shunting switch 49 may shunt second local p-n junction 46B such that the voltage drop across second local p-n junction 46B, and the voltage at second input 28, is zero.

In some examples, device 4D may include temperature module 20D which may be configured to perform operations similar to temperature module 20A of FIG. 1 and/or temperature module 20C of FIG. 3. For instance, temperature module 20D may be configured to determine the temperature of a p-n junction. In contrast to device temperature module 20A, temperature module 20D may be configured to determine the temperature of a remote p-n junction without the error introduced by a bandgap reference. In contrast to device 4C, device 4D may be configured to determine the temperature of a remote p-n junction. Additionally, temperature module 20C may be configured to determine and output first phase control signal 50A, second phase control signal 50B, clock signal 41, and multiplexer control signal 68. In some examples, temperature module 20D is configured to determine the temperature of remote p-n junction 8D by performing a local sensing operation to determine a first value based on local p-n junctions 46, and a mixed sensing operation to determine a second value based on remote p-n junction 8D and one or both of local p-n junctions 46. Temperature module 20D may be configured to determine the temperature of remote p-n junction 8D based on the first value and the second value.

In some examples, system 2D may include remote sensor core 5D which may be configured to perform operations similar to remote sensor core 5A of FIG. 1. For instance, remote sensor core 5D may be configured to sense a temperature. For instance and as illustrated in FIG. 4, remote sensor core 5D may include remote p-n junction 8D which, as discussed above, may be configured to output a voltage signal as a function of temperature. Examples of remote p-n junction 8D include, but are not limited to, diodes, transistors, and the like.

In some examples, system 2D may include S&H 70 which may be configured to sample a signal at a first time, hold (e.g., store) the sample of the signal, and output the same signal at a second time. For instance, S&H 70 may be configured to sample and store a signal that corresponds to the voltage drop across remote p-n junction 8D, e.g., in response to receiving a logical high signal from first phase control signal 50A. S&H 70 may also be configured to output the stored signal to multiplexer 66, e.g., in response to receiving a logical high signal from second phase control signal 50B. In some examples, S&H 70 may be configured to subtract a signal from the stored signal. As one example, during a first phase, S&H 70 may receive and store a first signal. During a second phase, S&H 70 may receive a second signal and determine an output signal by subtracting the second signal from the stored first signal. In other words, S&H 70 may include a subtractor. In some examples, S&H 70 may be integrated into an ADC, such as ADC 18D. For instance, S&H 70 may include a storage capacitor configured to first store a charge proportional to the voltage across remote p-n junction 8D while remote p-n junction 8D is biased at a first current, e.g., during a first phase. Then, the same capacitor of S&H 70 may store the charge proportional the voltage across remote p-n junction 8D while remote p-n junction 8D is biased at a second current and simultaneously subtract this charge from the charge stored during the first phase. In this way, S&H 70 may operate as a first integrator of a typical Discrete Time Sigma Delta ADC integrating only the difference in charge between the two voltages respectively generated during the first phase and the second phase.

In accordance with one or more techniques of this disclosure, temperature module 20D may determine a temperature of remote p-n junction 8D by performing a local sensing operation to determine a first value based on local p-n junctions 46, and a mixed sensing operation to determine a second value based on remote p-n junction 8D and one or both of local p-n junctions 46. In some examples, the first value may correspond to a temperature of one or both of local p-n junction 46 and the second value may correspond to the temperature of remote p-n junction 8D.

In some examples, temperature module 20D may perform the local sensing operation using techniques similar to the techniques used by temperature module 20C to determine the average value of bitstream 42 of FIG. 3. For instance, based on the value of a current bit of bitstream 42, temperature module 20D may cause ADC 18D to either integrate a ΔV_{BE local} value or a V_{BE} value. As one example, where the value of the current bit of bitstream 42 is a logical low value, temperature module 20D may cause ADC 18D to integrate a ΔV_{BE local} value. In some examples, temperature module 20D may cause system 2D to generate the ΔV_{BE local} value by biasing first local p-n junction 46A with a first current and second local p-n junction 46B with a second current. For instance, temperature module 20D may output phase control signals 50 such that current sources 6D and switch network 8D bias first local p-n junction 46A with the first current and second local p-n junction 46B with the second current. Additionally, during the local sensing operation, temperature module 20D may output multiplexer control signal 68 so as to cause multiplexer 66 to couple first local p-n junction 46A to first input 26. Therefore, because first input 26 is coupled to first local p-n junction 46A and second input 28 is coupled to second local p-n junction 46B, the voltage drop at the input of ADC 18D may be the ΔV_{BE local} value during the local sensing operation where the value of the current bit of bitstream 42 is the logical low value.

In other words, temperature module 20D may determine, based at least on a first delta voltage value (i.e., ΔV_{BE local}) that represents a difference between a pair of local voltage values, a first value that corresponds to a temperature of local sensor core 44D, where a first voltage value of the pair of local voltage values corresponds to a voltage drop across one of local p-n junctions 46 of local sensor core 44D. In some examples, the first value may be the portion of bitstream 42 generated during the local sensing operation. For instance, if temperature module 20D causes system 2D to perform the local sensing operation for 100 bits, the first value may be the average value of the 100 bits.

In some examples, temperature module 20D may cause ADC 18D to integrate the ΔV_{BE local} value in a single phase. For instance, as opposed to integrating the ΔV_{BE local} value in two phases by swapping the biasing currents of local p-n junctions 46, temperature module 20D may cause ADC 18D to integrate the ΔV_{BE local} value without swapping the currents.

In some examples, temperature module 20D may perform the mixed sensing operation using techniques similar to the techniques used by temperature module 20C to determine the average value of bitstream 42 of FIG. 3. For instance, based on the value of bit stream 42, temperature module 20D may cause ADC 18D to integrate one of two values. However, during the mixed sensing operation, the two values may be a ΔV_{BE remote} value and a V_{BE} value (i.e., as opposed to a ΔV_{BE local} value and a V_{BE} value). In some examples, the ΔV_{BE remote} value may correspond to a difference between a voltage drop across remote p-n junction 8D while remote p-n junction 8D is biased with a fourth current and a voltage drop across remote p-n junction 8D while remote p-n junction 8D is biased with a fifth current. In some examples, the V_{BE} value may correspond to a voltage drop across first local p-n junction 46A while first local p-n junction 46A is biased with a sixth current. In this way, temperature module 20D may determine the V_{BE} value for both the local and mixed sensing operations based on a voltage drop across a local p-n junction.

In some examples, temperature module 20D may cause system 2D to generate the ΔV_{BE remote} value in two phases. During a first phase, temperature module 20D may cause current sources 6D and switch network 8D to bias remote p-n junction 8D with the fourth current (e.g., I₄) and cause S&H 70 to store a sample of the voltage drop across remote p-n junction 8D while remote p-n junction 8D is biased at the fourth current (i.e., V_{8D@ I4}). During a second phase, temperature module 20D may cause current sources 6D and switch network 8D to bias remote p-n junction 8D with the fifth current (e.g., I₅) and cause S&H 70 to subtract the voltage drop across remote p-n junction 8D while remote p-n junction 8D is biased at the fifth current (i.e., V_{8D@ I5}) from the stored sample of the voltage drop across remote p-n junction 8D while remote p-n junction 8D was biased at the fourth current (i.e., V_{8D@ I4}) to determine the ΔV_{BE remote} value. In some examples, the fourth current may be a ratiometric current of the fifth current (e.g. I₄=I₅*N, where N is an integer multiplier). S&H 70 may then output the ΔV_{BE remote} value to multiplexer 66 which may pass the ΔV_{BE remote} value to first input 26. Additionally, in some examples, temperature module 20D may cause shunting switch 49 to close while integrating the ΔV_{BE remote} value such that the voltage across first input 26 and second input 28 corresponds to the ΔV_{BE remote} value. As discussed above, temperature module 20D may cause the components of system 2D to operate in the different phases by selectively outputting control signals 50, and/or multiplexer control signal 68.

In other words, temperature module 20D may perform the mixed sensing operation by determining, based on a local voltage value and second delta voltage value that represents a difference between a pair of remote voltage values (i.e., ΔV_{BE remote}), a second value that corresponds to a temperature of remote p-n junction 8D where the local voltage value corresponds to a second voltage drop across one of local p-n junctions 46 and the pair of mixed voltage values each correspond to a respective voltage drop across remote p-n junction 8D while remote p-n junction 8D is biased at different respective current levels. In some examples, the second value may be the portion of bitstream 42 generated during the mixed sensing operation. For instance, if temperature module 20D causes system 2D to perform the mixed sensing operation for 100 bits, the second value may be the average value of the 100 bits. In some examples, temperature module 20D may cause system 2D to perform the mixed sensing operation to determine the same quantity of bits as determined during the local sensing operation. In some examples, temperature module 20D may cause system 2D to perform the mixed sensing operation to determine a different quantity of bits as determined during the local sensing operation.

In some examples, the fourth current used during the mixed sensing operation may be similar to the first current used during the local sensing operation. In some examples, the fifth current used during the mixed sensing operation may be similar to the second current used during the local sensing operation. In some examples, the sixth current used during the mixed sensing operation may be similar to the third current used during the local sensing operation.

In any case, temperature module 20D may determine the temperature of remote p-n junction 8D in accordance with equation (8), below, where T_{R} is the temperature of remote p-n junction 8D, T_{L} is the temperature of one or both of local p-n junctions 46, μ_{L} is the first value (e.g., the duty cycle/average value of bitstream 42 determined by ADC 18D during the local sensing operation), μ_{R} is the second value (e.g., the duty cycle/average value of bitstream 42 determined by ADC 18D during the mixed sensing operation), N_{L} is a ratio of the first current level to the second current level, and N_{R} is a ratio of the fourth current level to the fifth current level. In this way, temperature module 20D may determine the temperature of remote p-n junction 8D without errors being introduced by the use of a temperature invariant current source.

$${T}_{R} = \frac{ln ( {N}_{L} )}{ln ( {N}_{R} )} \cdot \frac{1 - {μ}_{L}}{1 - {μ}_{R}} \cdot \frac{{μ}_{R}}{{μ}_{L}} \cdot {T}_{L} \qquad ( 8 )$$

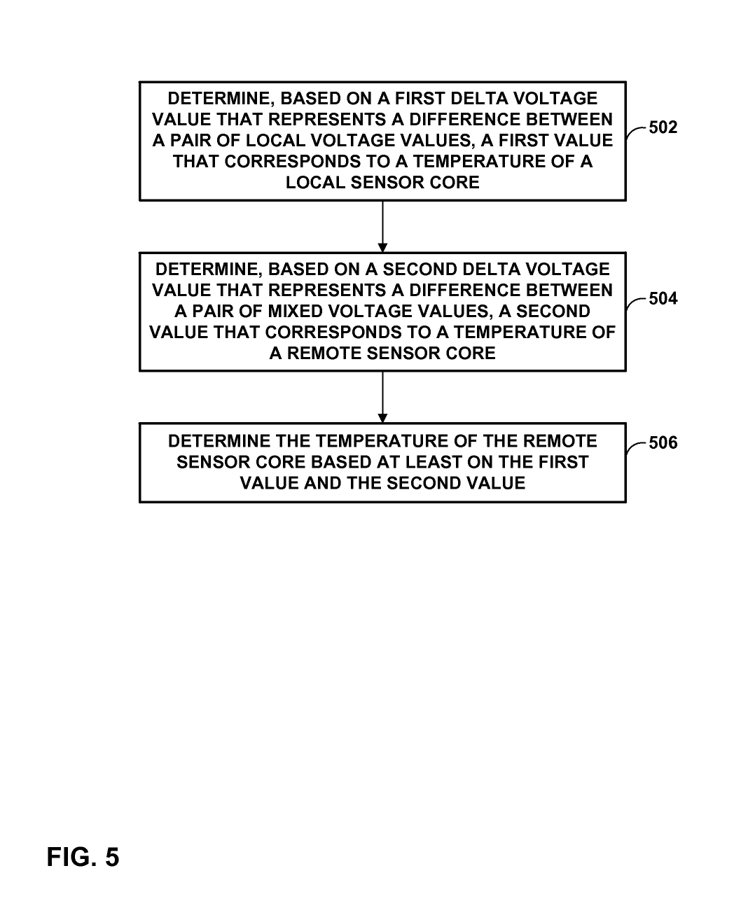

FIG. 5 is a flowchart illustrating example operations of a device configured to determine the temperature of a remote p-n junction, in accordance with one or more techniques of this disclosure. For purposes of illustration only, the example operations are described below within the context of device 4D, as shown in FIG. 4.

In the example of FIG. 4, device 4D may determine, based on a first delta voltage value that represents a difference between a pair of local voltage values, a first value that corresponds to a temperature of a local sensor core (502). In some examples, a first voltage value of the pair of local voltage values may correspond to a voltage drop across a local p-n junction of the local sensor core. In some examples, the first value may represent the average value of a bitstream generated by a charge-sharing sigma-delta ADC (e.g., ADC 18D) during a local sensing operation.

Device 4D may determine, based on a second delta voltage value that represents a difference between a pair of mixed voltage values, a second value that corresponds to a temperature of a remote sensor core (504). In some examples, a first voltage value of the pair of mixed voltage values may correspond to the voltage drop across the local p-n junction of the local sensor core and a second voltage value of the pair of mixed voltage values may correspond to a voltage drop across a remote p-n junction of the remote sensor core. In some examples, the second value may represent the average value of a bitstream generated by a charge-sharing sigma-delta ADC (e.g., ADC 18D) during a mixed sensing operation.

Device 4D may then determine the temperature of the remote sensor core based at least on the first value and the second value (506). In some examples, device 4D may determine the temperature of the remote sensor core in accordance with equation (8), above.

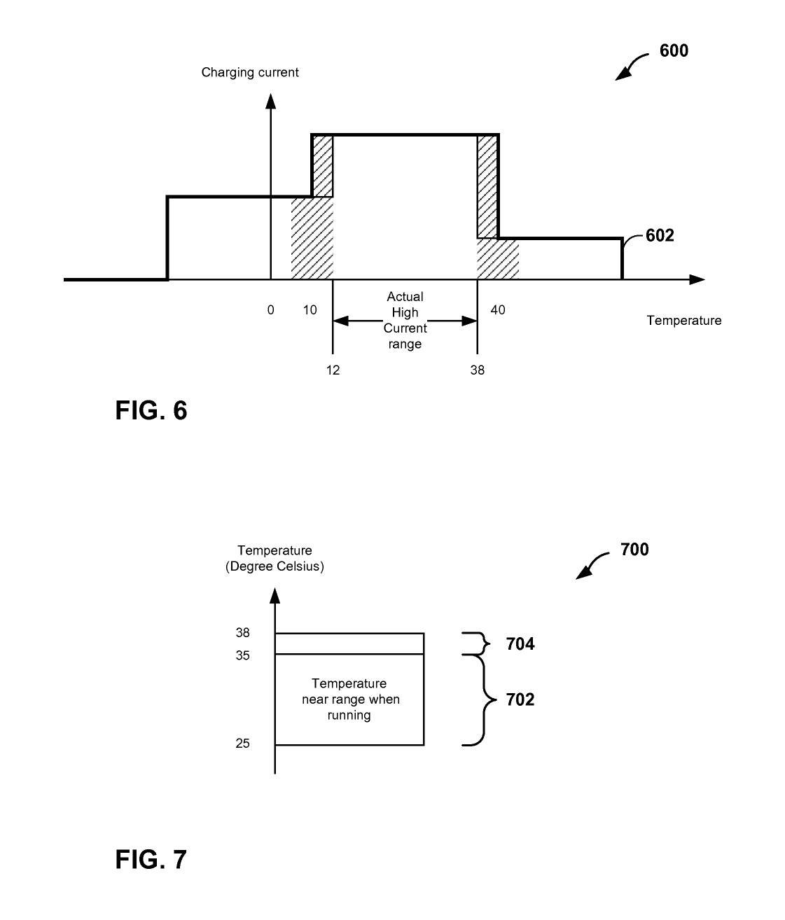

FIG. 6 is a graph illustrating an example relationship between charging current and temperature of a battery, in accordance with one or more techniques of this disclosure. As illustrated by FIG. 6, graph 600 includes a horizontal axis that indicates a temperature of an example battery a vertical axis that indicates a charging current of the battery, and plot 602 that indicates a maximum allowable charging current of the battery. In some examples, an error may be introduced when measuring the temperature of the battery. For instance, the temperature of the battery may be determined with +/−2 degrees Celsius accuracy. As such, if the determined temperature of the battery is 40 degrees Celsius, the actual temperature of the battery may be between 38 and 42 degrees Celsius. As illustrated by plot 602, the maximum charging current of the battery may vary based on the determined temperature. In some examples, in order to comply with the temperature based maximum charging current, the battery may only be charged based on the “worst case” temperature. For instance, if the determined temperature of the battery is 40 degrees Celsius with +/−2 degrees Celsius accuracy, the maximum charging current for the battery may be determined as if the temperature of the battery is 38 degrees Celsius.

As discussed above, a device (e.g., device 4D of FIG. 4) may utilize a p-n junction to measure a temperature. For instance, device 4D may utilize remote p-n junction 8D to measure the temperature of a battery. In accordance with one or more techniques of this disclosure, the device may reduce the error introduced when measuring the temperature of the battery. In this way, the device may improve the accuracy of the measured temperature of the battery such that the “worst case” temperature is not as low, which may allow charging of the battery at an increased current level. In this way, the device may reduce the amount of time needed to charge the battery.

FIG. 7 is a graph illustrating example temperature levels of a battery, in accordance with one or more techniques of this disclosure. As illustrated by FIG. 7, graph 700 includes a vertical axis that indicates a temperature of a battery. As shown by graph 700, when a device is running/operating (e.g., drawing current from the battery), the determined temperature of the battery may be within range 702 (e.g., from approximately room temperature/25 degrees Celsius to approximately 35 degrees Celsius). However, in some examples, when the battery is charging, the temperature of the battery may rise above range 702 and enter range 704 (e.g., from approximately 35 degrees Celsius to 38 degrees Celsius).

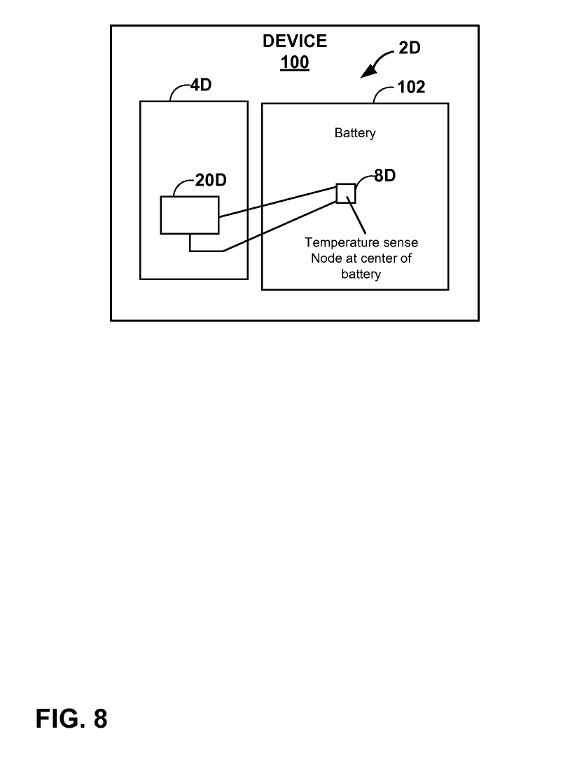

FIG. 8 is a conceptual diagram illustrating an exemplary system that includes a device for determining the temperature of a remote p-n junction that is physically located near a battery, in accordance with one or more techniques of this disclosure. As illustrated in FIG. 8, device 100 may include system 2D and battery 102. As discussed above, in some examples, system 2D may include device 4D (which may include temperature module 20D), and remote p-n junction 8D. As illustrated in FIG. 8, in some examples, remote p-n junction 8D may be positioned at a center of battery 102. In this way, the temperature of remote p-n junction 8D, and by association the temperature determined by temperature module 20D, may more accurately reflect the temperature of battery 102. In other words, the techniques of this disclosure may enable device 4D to more accurately determine the temperature of remote p-n junction 8D where the temperature of remote p-n junction 8D is different than the temperature of device 4D. In some examples, the temperature of remote p-n junction 8D may be different than the temperature of device 4D where remote p-n junction 8D is located near a heat source, such as battery 102.

The following examples may illustrate one or more aspects of the disclosure:

### Example 1

A method comprising: determining, based on a first local V_{BE} value and a local ΔV_{BE} value that represents a difference between a pair of local voltage values, a first value that corresponds to a temperature of a local sensor core, wherein a first local voltage value of the pair of local voltage values corresponds to a first voltage drop across a local p-n junction of the local sensor core, and wherein the first local V_{BE} value corresponds to a second voltage drop across the local p-n junction of the local sensor core; determining, based on a second local V_{BE} value and a remote ΔV_{BE} value that represents a difference between a pair of remote voltage values, a second value that corresponds to a temperature of a remote sensor core, wherein the second local V_{BE} value corresponds to a third voltage drop across the local p-n junction, and wherein the pair of remote voltage values each correspond to respective voltage drops across a remote p-n junction of the remote sensor core while the remote p-n junction is biased at different respective current levels; and determining the temperature of the remote sensor core based at least on the first value and the second value.

### Example 2

The method of example 1, wherein the first value is a first duty cycle of a charge sharing sigma-delta analog-to-digital converter (ADC) configured to generate a bitstream, and wherein the second value is a second duty cycle of the ADC.

### Example 3

The method of any combination of examples 1-2, wherein the determining the second value comprises: integrating, by the ADC and during a mixed sensing operation, the remote ΔV_{BE} value to determine a next bit of the bitstream in response to determining that a current bit of the bitstream is a first logical value; integrating, by the ADC and during the mixed sensing operation, the second local V_{BE} value to determine the next bit of the bitstream in response to determining that the current bit of the bitstream is a second logical value; and determining the second duty cycle of the ADC based on the bitstream determined by the ADC during the mixed sensing operation.

### Example 4

The method of any combination of examples 1-3, wherein determining the first value comprises: integrating, by the ADC and during a local sensing operation, the local ΔV_{BE} value to determine the next bit of the bitstream in response to determining that the current bit of the bitstream is the first logical value; integrating, by the ADC and during the local sensing operation, the first local V_{BE} value to determine the next bit of the bitstream in response to determining that the current bit of the bitstream is the second logical value; and determining the first duty cycle of the ADC based on the bitstream determined by the ADC during the local sensing operation.

### Example 5

The method of any combination of examples 1-4, wherein the bitstream determined by the ADC during the local sensing operation includes a same quantity of logical values as the bitstream determined by the ADC during the mixed sensing operation.

### Example 6

The method of any combination of examples 1-5, wherein the temperature of the remote p-n junction is determined approximately according to the following equation:

$${T}_{R} = \frac{ln ( {N}_{L} )}{ln ( {N}_{R} )} \cdot \frac{1 - {μ}_{L}}{1 - {μ}_{R}} \cdot \frac{{μ}_{R}}{{μ}_{L}} \cdot {T}_{L}$$

wherein T_{R} is the temperature of the remote p-n junction, T_{L} is the temperature of the local sensor core, μ_{L} is the first duty cycle of the ADC, μ_{R} is the second duty cycle of the ADC, N_{L} is a ratio of current levels at which the local sensor core is biased during the local sensing operation, and N_{R} is a ratio of current levels at which the remote sensor core is biased during the mixed sensing operation.

### Example 7

The method of any combination of examples 1-6, further comprising determining the pair of remote voltage values represented by the remote ΔV_{BE} value by at least: determining, at a first time, a first remote voltage value of the pair of remote voltage values as a voltage drop across the remote p-n junction while the remote p-n junction is biased with a first current; and determining, at a second time, a second remote voltage value of the pair of remote voltage values as a voltage drop across the remote p-n junction while the remote p-n junction is biased with a second current.

### Example 8

The method of any combination of examples 1-7, further comprising determining the pair of local voltage values represented by the local ΔV_{BE} value by at least: determining, at a first time, the first local voltage value of the pair of local voltage values as a voltage drop across the local p-n junction while the local p-n junction is biased with a first current; and determining, at a second time, a second local voltage value of the pair of local voltage values as a voltage drop across the local p-n junction while the local p-n junction is biased with a second current.

### Example 9

The method of any combination of examples 1-7, wherein the local p-n junction is a first local p-n junction, the method further comprising determining the pair of local voltage values represented by the local ΔV_{BE} value by at least: determining the first local voltage value of the pair of local voltage values as a voltage drop across the first local p-n junction while the first local p-n junction is biased with a first current; and determining a second local voltage value of the pair of local voltage values as a voltage drop across a second local p-n junction of the local sensor core while the second local p-n junction is biased with a second current.

### Example 10

The method of any combination of examples 1-9, wherein the temperature of the remote sensor core is different than the temperature of the local sensor core.

### Example 11

A device comprising: an analog-to-digital converter (ADC) configured to determine, based on a first local V_{BE} value and a local ΔV_{BE} value that represents a difference between a pair of local voltage values, a first value that corresponds to a temperature of a local sensor core, wherein a first voltage value of the pair of local voltage values corresponds to a first voltage drop across a local p-n junction of the local sensor core, and wherein the first local V_{BE} value corresponds to a second voltage drop across the local p-n junction of the local sensor core, wherein the ADC is further configured to determine, based on a second local V_{BE} value and a remote ΔV_{BE} value that represents a difference between a pair of remote voltage values, a second value that corresponds to a temperature of a remote sensor core, wherein the second local V_{BE} value corresponds to a third voltage drop across the local p-n junction, and wherein the pair of mixed voltage values each correspond to respective voltage drops across a remote p-n junction of the remote sensor core while the remote p-n junction is biased at difference respective current levels; and one or more processors configured to determine the temperature of the remote sensor core based at least on the first value and the second value.

### Example 12

The device of example 11, wherein the ADC is a charge sharing sigma-delta ADC configured to generate a bitstream, and wherein the first value is a first duty cycle of the ADC, wherein the second value is a second duty cycle of the ADC.

### Example 13

The device of any combination of examples 11-12, wherein the ADC is configured to determine the second value by at least: integrating, during a mixed sensing operation and where a current bit of the bitstream is a first logical value, the remote ΔV_{BE} value to determine a next bit of the bitstream; integrating, during the mixed sensing operation and where the current bit of the bitstream is a second logical value, the second local V_{BE} value to determine the next bit of the bitstream; and determining the second duty cycle based on the bitstream determined during the mixed sensing operation.

### Example 14

The device of any combination of examples 11-13, wherein the ADC is configured to determine the first value by at least: integrating, during a local sensing operation and where the current bit of the bitstream is the first logical value, the local ΔV_{BE} value to determine a next bit of the bitstream; integrating, during the local sensing operation and where the current bit of the bitstream is the second logical value, the first local V_{BE} value to determine the next bit of the bitstream; and determining the first duty cycle based on the bitstream determined during the local sensing operation.

### Example 15

The device of any combination of examples 11-14, wherein the bitstream determined by the ADC during the local sensing operation includes a same quantity of logical values as the bitstream determined by the ADC during the mixed sensing operation.

### Example 16

The device of any combination of examples 11-15, wherein the one or more processors are configured to determine the temperature of the remote p-n junction is determined approximately according to the following equation:

$${T}_{R} = \frac{ln ( {N}_{L} )}{ln ( {N}_{R} )} \cdot \frac{1 - {μ}_{L}}{1 - {μ}_{R}} \cdot \frac{{μ}_{R}}{{μ}_{L}} \cdot {T}_{L}$$

wherein T_{R} is the temperature of the remote p-n junction, T_{L} is the temperature of the local sensor core, μ_{L} is the first duty cycle of the ADC, μ_{R} is the second duty cycle of the ADC, N_{L} is a ratio of current levels at which the local sensor core is biased during the local sensing operation, and N_{R} is a ratio of current levels at which the remote sensor core is biased during the mixed sensing operation.

### Example 17

The device of any combination of examples 11-16, further comprising: a sample & hold (S&H) configured to determine the remote ΔV_{BE} value by at least: determining, at a first time, a first remote voltage value of the pair of remote voltage values as a voltage drop across the remote p-n junction while the remote p-n junction is biased with a first current; determining, at a second time, a second remote voltage value of the pair of remote voltage values as a voltage drop across the remote p-n junction while the remote p-n junction is biased with a second current; and determining the remote ΔV_{BE} value as the difference between the pair of remote voltage values.

### Example 18

The device of any combination of examples 11-17, further comprising: a sample & hold (S&H) configured to determine the local ΔV_{BE} value by at least: determining, at a first time, the first local voltage value of the pair of local voltage values as a voltage drop across the local p-n junction while the local p-n junction is biased with a first current; determining, at a second time, a second local voltage value of the pair of local voltage values as a voltage drop across the local p-n junction while the local p-n junction is biased with a second current; and determining the local ΔV_{BE} value as the difference between the pair of local voltage values.

### Example 19

The device of any combination of examples 11-17, wherein the local p-n junction is a first local p-n junction, wherein the first local voltage value of the pair of local voltage values corresponds to a voltage drop across the first local p-n junction while the first local p-n junction is biased with a first current, and wherein a second local voltage value of the pair of local voltage values corresponds to a voltage drop across a second local p-n junction of the local sensor core while the second local p-n junction is biased with a second current.

### Example 20

The device of any combination of examples 11-19, wherein the temperature of the remote sensor core is different than the temperature of the local sensor core.

### Example 21

A device comprising: means for determining, based on a first local V_{BE} value and a local ΔV_{BE} value that represents a difference between a pair of local voltage values, a first value that corresponds to a temperature of a local sensor core, wherein a first local voltage value of the pair of local voltage values corresponds to a first voltage drop across a local p-n junction of the local sensor core, and wherein the first local V_{BE} value corresponds to a second voltage drop across the local p-n junction of the local sensor core; means for determining, based on a second local V_{BE} value and a remote ΔV_{BE} value that represents a difference between a pair of remote voltage values, a second value that corresponds to a temperature of a remote sensor core, wherein the second local V_{BE} value corresponds to a third voltage drop across the local p-n junction, and wherein the pair of remote voltage values each correspond to respective voltage drops across a remote p-n junction of the remote sensor core while the remote p-n junction is biased at different respective current levels; and means for determining the temperature of the remote sensor core based at least on the first value and the second value.

### Example 22

The device of example 21, wherein the means for determining the second value comprise a charge sharing sigma-delta analog-to-digital converter (ADC) configured to generate a bitstream, and wherein the first value is a first duty cycle of the ADC, wherein the second value is a second duty cycle of the ADC.

### Example 23

The device of any combination of examples 21-22, wherein the means for determining the second value comprise: means for integrating, during a mixed sensing operation and where a current bit of the bitstream is a first logical value, the remote ΔV_{BE} value to determine a next bit of the bitstream; means for integrating, during the mixed sensing operation and where the current bit of the bitstream is a second logical value, the second local V_{BE} value to determine the next bit of the bitstream; and means determining the second duty cycle of the ADC based on the bitstream determined by the ADC during the mixed sensing operation.

### Example 24

The device of any combination of examples 21-23, wherein the means for determining the first value comprise: means for integrating, during a local sensing operation and where the current bit of the bitstream is the first logical value, the local ΔV_{BE} value to determine the next bit of the bitstream; means for integrating, during the local sensing operation and where the current bit of the bitstream is a second logical value, the first local V_{BE} value to determine the next bit of the bitstream; and means determining the first duty cycle of the ADC based on the bitstream determined by the ADC during the local sensing operation.

### Example 25

The device of any combination of examples 21-24, wherein the temperature of the remote sensor core is different than the temperature of the local sensor core.

The techniques described in this disclosure may be implemented, at least in part, in hardware, software, firmware, or any combination thereof. For example, various aspects of the described techniques may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit including hardware may also perform one or more of the techniques of this disclosure.

Such hardware, software, and firmware may be implemented within the same device or within separate devices to support the various techniques described in this disclosure. In addition, any of the described units, modules, or components may be implemented together or separately as discrete but interoperable logic devices. Depiction of different features as modules or units is intended to highlight different functional aspects and does not necessarily imply that such modules or units must be realized by separate hardware, firmware, or software components. Rather, functionality associated with one or more modules or units may be performed by separate hardware, firmware, or software components, or integrated within common or separate hardware, firmware, or software components.

The techniques described in this disclosure may also be embodied or encoded in an article of manufacture including a computer-readable storage medium encoded with instructions. Instructions embedded or encoded in an article of manufacture including a computer-readable storage medium encoded, may cause one or more programmable processors, or other processors, to implement one or more of the techniques described herein, such as when instructions included or encoded in the computer-readable storage medium are executed by the one or more processors. Computer readable storage media may include random access memory (RAM), read only memory (ROM), programmable read only memory (PROM), erasable programmable read only memory (EPROM), electronically erasable programmable read only memory (EEPROM), flash memory, a hard disk, a compact disc ROM (CD-ROM), a floppy disk, a cassette, magnetic media, optical media, or other computer readable media. In some examples, an article of manufacture may include one or more computer-readable storage media.

In some examples, a computer-readable storage medium may include a non-transitory medium. The term “non-transitory” may indicate that the storage medium is not embodied in a carrier wave or a propagated signal. In certain examples, a non-transitory storage medium may store data that can, over time, change (e.g., in RAM or cache).

Various aspects have been described in this disclosure. These and other aspects are within the scope of the following claims.

1. A method comprising:
determining, based on a first local V_{BE} value and a local ΔV_{BE} value that represents a difference between a pair of local voltage values, a first value that corresponds to a temperature of a local sensor core, wherein a first local voltage value of the pair of local voltage values corresponds to a first voltage drop across a local p-n junction of the local sensor core, and wherein the first local V_{BE} value corresponds to a second voltage drop across the local p-n junction of the local sensor core;
determining, based on a second local V_{BE} value and a remote ΔV_{BE} value that represents a difference between a pair of remote voltage values, a second value that corresponds to a temperature of a remote sensor core, wherein the second local V_{BE} value corresponds to a third voltage drop across the local p-n junction, and wherein the pair of remote voltage values each correspond to respective voltage drops across a remote p-n junction of the remote sensor core while the remote p-n junction is biased at different respective current levels; and
determining the temperature of the remote sensor core based at least on the first value and the second value.

2. The method of claim 1, wherein the first value is a first duty cycle of a charge sharing sigma-delta analog-to-digital converter (ADC) configured to generate a bitstream, and wherein the second value is a second duty cycle of the ADC.

3. The method of claim 2, wherein the determining the second value comprises:
integrating, by the ADC and during a mixed sensing operation, the remote ΔV_{BE} value to determine a next bit of the bitstream in response to determining that a current bit of the bitstream is a first logical value;
integrating, by the ADC and during the mixed sensing operation, the second local V_{BE} value to determine the next bit of the bitstream in response to determining that the current bit of the bitstream is a second logical value; and
determining the second duty cycle of the ADC based on the bitstream determined by the ADC during the mixed sensing operation.

4. The method of claim 3, wherein determining the first value comprises:
integrating, by the ADC and during a local sensing operation, the local ΔV_{BE} value to determine the next bit of the bitstream in response to determining that the current bit of the bitstream is the first logical value;
integrating, by the ADC and during the local sensing operation, the first local V_{BE} value to determine the next bit of the bitstream in response to determining that the current bit of the bitstream is the second logical value; and
determining the first duty cycle of the ADC based on the bitstream determined by the ADC during the local sensing operation.

5. The method of claim 4, wherein the bitstream determined by the ADC during the local sensing operation includes a same quantity of logical values as the bitstream determined by the ADC during the mixed sensing operation.

6. The method of claim 4,
wherein the temperature of the remote p-n junction is determined approximately according to the following equation:
$${T}_{R} = \frac{ln ( {N}_{L} )}{ln ( {N}_{R} )} \cdot \frac{1 - {μ}_{L}}{1 - {μ}_{R}} \cdot \frac{{μ}_{R}}{{μ}_{L}} \cdot {T}_{L}$$
wherein T_{R} is the temperature of the remote p-n junction, T_{L} is the temperature of the local sensor core, μ_{L} is the first duty cycle of the ADC, μ_{R} is the second duty cycle of the ADC, N_{L} is a ratio of current levels at which the local sensor core is biased during the local sensing operation, and N_{R} is a ratio of current levels at which the remote sensor core is biased during the mixed sensing operation.

7. The method of claim 1, further comprising determining the pair of remote voltage values represented by the remote ΔV_{BE} value by at least:
determining, at a first time, a first remote voltage value of the pair of remote voltage values as a voltage drop across the remote p-n junction while the remote p-n junction is biased with a first current; and
determining, at a second time, a second remote voltage value of the pair of remote voltage values as a voltage drop across the remote p-n junction while the remote p-n junction is biased with a second current.

8. The method of claim 1, further comprising determining the pair of local voltage values represented by the local ΔV_{BE} value by at least:
determining, at a first time, the first local voltage value of the pair of local voltage values as a voltage drop across the local p-n junction while the local p-n junction is biased with a first current; and
determining, at a second time, a second local voltage value of the pair of local voltage values as a voltage drop across the local p-n junction while the local p-n junction is biased with a second current.

9. The method of claim 1, wherein the local p-n junction is a first local p-n junction, the method further comprising determining the pair of local voltage values represented by the local ΔV_{BE} value by at least:
determining the first local voltage value of the pair of local voltage values as a voltage drop across the first local p-n junction while the first local p-n junction is biased with a first current; and
determining a second local voltage value of the pair of local voltage values as a voltage drop across a second local p-n junction of the local sensor core while the second local p-n junction is biased with a second current.

10. The method of claim 1, wherein the temperature of the remote sensor core is different than the temperature of the local sensor core.

11. A device comprising:
an analog-to-digital converter (ADC) configured to determine, based on a first local V_{BE} value and a local ΔV_{BE} value that represents a difference between a pair of local voltage values, a first value that corresponds to a temperature of a local sensor core, wherein a first voltage value of the pair of local voltage values corresponds to a first voltage drop across a local p-n junction of the local sensor core, and wherein the first local V_{BE} value corresponds to a second voltage drop across the local p-n junction of the local sensor core,
wherein the ADC is further configured to determine, based on a second local V_{BE} value and a remote ΔV_{BE} value that represents a difference between a pair of remote voltage values, a second value that corresponds to a temperature of a remote sensor core, wherein the second local V_{BE} value corresponds to a third voltage drop across the local p-n junction, and wherein the pair of mixed voltage values each correspond to respective voltage drops across a remote p-n junction of the remote sensor core while the remote p-n junction is biased at difference respective current levels; and
one or more processors configured to determine the temperature of the remote sensor core based at least on the first value and the second value.

12. The device of claim 11, wherein the ADC is a charge sharing sigma-delta ADC configured to generate a bitstream, and wherein the first value is a first duty cycle of the ADC, wherein the second value is a second duty cycle of the ADC.

13. The device of claim 12, wherein the ADC is configured to determine the second value by at least:
integrating, during a mixed sensing operation and where a current bit of the bitstream is a first logical value, the remote ΔV_{BE} value to determine a next bit of the bitstream;
integrating, during the mixed sensing operation and where the current bit of the bitstream is a second logical value, the second local V_{BE} value to determine the next bit of the bitstream; and
determining the second duty cycle based on the bitstream determined during the mixed sensing operation.

14. The device of claim 13, wherein the ADC is configured to determine the first value by at least:
integrating, during a local sensing operation and where the current bit of the bitstream is the first logical value, the local ΔV_{BE} value to determine a next bit of the bitstream;
integrating, during the local sensing operation and where the current bit of the bitstream is the second logical value, the first local V_{BE} value to determine the next bit of the bitstream; and
determining the first duty cycle based on the bitstream determined during the local sensing operation.

15. The device of claim 14, wherein the bitstream determined by the ADC during the local sensing operation includes a same quantity of logical values as the bitstream determined by the ADC during the mixed sensing operation.

16. The device of claim 14,
wherein the one or more processors are configured to determine the temperature of the remote p-n junction is determined approximately according to the following equation:
$${T}_{R} = \frac{ln ( {N}_{L} )}{ln ( {N}_{R} )} \cdot \frac{1 - {μ}_{L}}{1 - {μ}_{R}} \cdot \frac{{μ}_{R}}{{μ}_{L}} \cdot {T}_{L}$$
wherein T_{R} is the temperature of the remote p-n junction, T_{L} is the temperature of the local sensor core, μ_{L} is the first duty cycle of the ADC, μ_{R} is the second duty cycle of the ADC, N_{L} is a ratio of current levels at which the local sensor core is biased during the local sensing operation, and N_{R} is a ratio of current levels at which the remote sensor core is biased during the mixed sensing operation.

17. The device of claim 11, further comprising:
a sample & hold (S&H) configured to determine the remote ΔV_{BE} value by at least:
determining, at a first time, a first remote voltage value of the pair of remote voltage values as a voltage drop across the remote p-n junction while the remote p-n junction is biased with a first current;
determining, at a second time, a second remote voltage value of the pair of remote voltage values as a voltage drop across the remote p-n junction while the remote p-n junction is biased with a second current; and
determining the remote ΔV_{BE} value as the difference between the pair of remote voltage values.

18. The device of claim 11, further comprising:
a sample & hold (S&H) configured to determine the local ΔV_{BE} value by at least:
determining, at a first time, the first local voltage value of the pair of local voltage values as a voltage drop across the local p-n junction while the local p-n junction is biased with a first current;
determining, at a second time, a second local voltage value of the pair of local voltage values as a voltage drop across the local p-n junction while the local p-n junction is biased with a second current; and
determining the local ΔV_{BE} value as the difference between the pair of local voltage values.

19. The device of claim 11, wherein the local p-n junction is a first local p-n junction, wherein the first local voltage value of the pair of local voltage values corresponds to a voltage drop across the first local p-n junction while the first local p-n junction is biased with a first current, and wherein a second local voltage value of the pair of local voltage values corresponds to a voltage drop across a second local p-n junction of the local sensor core while the second local p-n junction is biased with a second current.

20. The device of claim 11, wherein the temperature of the remote sensor core is different than the temperature of the local sensor core.

21. A device comprising:
means for determining, based on a first local V_{BE} value and a local ΔV_{BE} value that represents a difference between a pair of local voltage values, a first value that corresponds to a temperature of a local sensor core, wherein a first local voltage value of the pair of local voltage values corresponds to a first voltage drop across a local p-n junction of the local sensor core, and the first local V_{BE} value corresponds to a second voltage drop across the local p-n junction of the local sensor core;
means for determining, based on a second local V_{BE} value and a remote ΔV_{BE} value that represents a difference between a pair of remote voltage values, a second value that corresponds to a temperature of a remote sensor core, wherein the second local V_{BE} value corresponds to a third voltage drop across the local p-n junction, and wherein the pair of remote voltage values each correspond to respective voltage drops across a remote p-n junction of the remote sensor core while the remote p-n junction is biased at different respective current levels; and
means for determining the temperature of the remote sensor core based at least on the first value and the second value.

22. The device of claim 21, wherein the means for determining the second value comprise a charge sharing sigma-delta analog-to-digital converter (ADC) configured to generate a bitstream, and wherein the first value is a first duty cycle of the ADC, wherein the second value is a second duty cycle of the ADC.

23. The device of claim 22, wherein the means for determining the second value comprise:
means for integrating, during a mixed sensing operation and where a current bit of the bitstream is a first logical value, the remote ΔV_{BE} value to determine a next bit of the bitstream;
means for integrating, during the mixed sensing operation and where the current bit of the bitstream is a second logical value, the second local V_{BE} value to determine the next bit of the bitstream; and
means determining the second duty cycle of the ADC based on the bitstream determined by the ADC during the mixed sensing operation.

24. The device of claim 23, wherein the means for determining the first value comprise:
means for integrating, during a local sensing operation and where the current bit of the bitstream is the first logical value, the local ΔV_{BE} value to determine the next bit of the bitstream;
means for integrating, during the local sensing operation and where the current bit of the bitstream is a second logical value, the first local V_{BE} value to determine the next bit of the bitstream; and
means determining the first duty cycle of the ADC based on the bitstream determined by the ADC during the local sensing operation.

25. The device of claim 21, wherein the temperature of the remote sensor core is different than the temperature of the local sensor core.
